(19) United States
(12) Patent Application Publication
(10) Pub. No.: US 2014/0365013 A1
(43) Pub. Date: Dec. 11, 2014

(54) CONTROL SYSTEM

(71) Applicant: HÖGANÄS AB (Publ), Höganäs (SE)

(72) Inventor: Raissa Kruse, Hoor (SE)

(21) Appl. No.: 14/366,104

(22) PCT Filed: Dec. 18, 2012
(86) PCT No.: PCT/EP2012/076001

§ 371 Date: Jun. 17, 2014

(30) Foreign Application Priority Data
Dec. 23, 2011 (EP) 11195481.4

(51) Int. Cl. H02P 29/00; G05D 17/02; G05B 15/02

(52) U.S. Cl. CPC H02P 29/00; G05B 15/02; G05D 17/02
USPC 700/275

(57) ABSTRACT

A method for controlling and regulating an electrical auxiliary motor suitable for a pedal-driven vehicle including a crank axle, such as a bicycle, in such a way that said electrical auxiliary motor assists a user in rotating said crank axle by muscular force, the method including: a) receiving information about the specific torque T_{PSet} said user would like to generate when rotating said crank axle by muscular force; b) determining the actual torque T_{P} generated by the user on the crank axle; and c) for each T_{P}, adjusting the torque generated by the electrical auxiliary motor T_{M} in such a way that: T_{M} is increased in case T_{P} is higher than T_{PSet}; T_{M} is not changed in case T_{P} is equal to T_{PSet}; T_{M} is reduced in case T_{P} is lower than T_{PSet}; and T_{M} is 0 in case T_{P} is 0.

### TECHNICAL FIELD

Embodiments of the disclosure relate to the field of vehicles, and more specifically to the field of power-assisted pedal-driven vehicles comprising a crank axle, and an electrical auxiliary motor such as electrically assisted bicycles. The disclosure provides a method for controlling an electrical auxiliary motor, a system for implementing said method, as well as a power-assisted pedal-driven vehicle comprising the system.

### TECHNICAL BACKGROUND

It is known to provide a manually powered vehicle with an electric auxiliary motor so as to assist the user in the manual propulsion of the vehicle. U.S. Pat. No. 5,370,200 shows a manually powered vehicle such as a bicycle wherein there is provided an electrical auxiliary motor for assisting the user in the powering of the vehicle. This type of mechanism includes an arrangement that senses the manual input force or torque exerted by the occupant and then powers an electric motor by connecting it to a battery in such a way so as to provide a degree of assist in proportion to the manual input force.

This type of vehicle has a large number of advantages. However, it is important to ensure that the amount of electrical power supplied to the electric motor cannot be too great under certain circumstances so as to permit the speed of the vehicle to become excessive. In addition, it should be ensured that the system will not permit the user to bypass the control and to operate the electric motor manually, which may also result in excessive speed of the vehicle and/or unnecessary consumption of electric power which would reduce potential operation range of the vehicle. However, the user of such a vehicle cannot set or fine-tune the proportion between power output from the electric motor and his/her own muscle power.

DE 10 2009 029 655 A1 discloses a pedal-driven vehicle comprising an electric auxiliary motor where the regulation is focused on how to provide a constant torque on the crank axle during a complete rotation. In this document, it is pointed out that torque provided by a user varies with the angle of the crank axle. The control system identifies the maximum torque provided by the user during a full rotation and then instructs the electric auxiliary motor to provide additional torque up to this maximum amount during the next full rotation. However, the user of such a vehicle is not able to control the amount of power he has to produce in relation to the electric auxiliary motor.

There is a need for a control system for a manually powered vehicle with an electric assist where the user directly may select the amount of muscle power required of him/her when using the vehicle.

### SUMMARY

In a first embodiment, the disclosure provides a method for controlling and regulating an electrical auxiliary motor suitable for a pedal-driven vehicle comprising a crank axle, such as a bicycle, in such a way that said electrical auxiliary motor assists a user in rotating said crank axle by muscular force, and comprising the steps of
a) receiving information about the specific torque T_{PSet} said user would like to generate when rotating said crank axle by muscular force;
b) determining the actual torque T_{P} generated by the user on the crank axle;
c) for each T_{P}, adjusting the torque generated by the electrical auxiliary motor T_{M} in such a way that:
   T_{M} is increased in case T_{P} is higher than T_{PSet};
   T_{M} is not changed in case T_{P} is equal to T_{PSet};
   T_{M} is reduced in case T_{P} is lower than T_{PSet}; and
   T_{M} is 0 in case T_{P} is 0.

In a second embodiment, the disclosure provides a system for controlling and regulating an electrical auxiliary motor suitable for a pedal-driven vehicle comprising a crank axle, such as a bicycle, said system comprising:
a) a means for receiving information about the specific torque T_{PSet} a user would like to generate when rotating said crank axle by muscular force;
b) a means for determining the actual torque T_{P} generated by the user on the crank axle; and
c) a control and calculation means;
wherein
said means for receiving information about the specific torque T_{PSet} is set up to forward said information to said control and calculation means;
said means for determining the actual torque T_{P} is set up to forward information about said torque to said control and calculation means;
said control and calculation means is set up to receive information about the specific torque T_{PSet} a user would like to generate when rotating said crank axle by muscular force from said means for receiving information about the specific torque T_{PSet}; and
said control and calculation means is set up to adjust the torque generated by the electrical auxiliary motor T_{M} in response to reception of a new T_{P} value in such a way that:
   T_{M} is increased in case T_{P} is higher than T_{PSet};
   T_{M} is not changed in case T_{P} is equal to T_{PSet};
   T_{M} is reduced in case T_{P} is lower than T_{PSet}; and
   T_{M} is 0 in case T_{P} is 0.

In a third embodiment, the disclosure provides a power-assisted pedal-driven vehicle comprising a crank axle, and an electrical auxiliary motor such as an electrically assisted bicycle, wherein an electrical auxiliary motor assists a user in rotating said crank axle by muscular force, and where the power to move the vehicle forward is transmitted from said crank axle to driving means such as a wheel or a propeller, said power-assisted pedal-driven vehicle, wherein the electrical auxiliary motor is regulated by a system according to the second embodiment.

### BRIEF DESCRIPTION OF THE DRAWINGS

The disclosure will now be further described with reference to the enclosed figures in which:

FIG. 1 shows a power-assisted bicycle according to a preferred embodiment of the disclosure;

FIG. 2 discloses the rear hub of the bicycle in FIG. 1;

FIG. 3 describes the crank set of the bicycle in FIG. 1;

FIG. 4 outlines the system for controlling the electric auxiliary motor of the bicycle in FIG. 1; and

FIG. 5 schematically discloses an example of an algorithm for controlling said electric auxiliary motor.

### DETAILED DESCRIPTION

Embodiments of the disclosure may solve the above mentioned objective problem.

Accordingly, in a first embodiment, the disclosure provides a method for controlling and regulating an electrical auxiliary motor suitable for a pedal-driven vehicle comprising a crank axle, such as a bicycle, in such a way that said electrical auxiliary motor assists a user in rotating said crank axle by muscular force, and comprising the steps of
a) receiving information about the specific torque T_{PSet} said user would like to generate when rotating said crank axle by muscular force;
b) determining the actual torque T_{P} generated by the user on the crank axle;
c) for each T_{P}, adjusting the torque generated by the electrical auxiliary motor T_{M} in such a way that:
   T_{M} is increased in case T_{P} is higher than T_{PSet};
   T_{M} is not changed in case T_{P} is equal to T_{PSet};
   T_{M} is reduced in case T_{P} is lower than T_{PSet}; and
   T_{M} is 0 in case T_{P} is 0.

As disclosed herein, the terms “vehicle” or “pedal-driven vehicle comprising a crank axle” both typically relate to bicycles but also any other pedal-driven vehicle such as a pedal-driven boat, a pedal-driven car and even a pedal-driven airplane, as long as the pedals are connected to a crank axle and the vehicle is driven by power transferred from this crank axle.

As disclosed herein, the term “electrical auxiliary motor” relates to any such motor suitable for a pedal-driven vehicle comprising a crank axle. In case the pedal-driven vehicle is a bicycle, it is preferred to arrange the electrical auxiliary motor inside the hub of the rear wheel. In that case, the amount of space is limited and it is therefore beneficial to use a motor providing high output power in relation to its volume. Examples of such motors and parts thereof can be found in WO 2007/024184, WO 2009/116935, WO 2009/116936, WO 2009/116937, WO 2011/033106, WO 2011/076740 and WO 2011/076579.

It is preferred that step a) is carried out in such a way that the information about the specific torque that the user would like to generate is entered manually.

Alternatively, it is preferred that step a) is carried out in such a way that the user indicates that the torque generated by him/her at a specific point of time is the specific torque that the user would like to generate, that specific torque is determined and referred to as T_{PSet}.

It is preferred that the torque T_{P} generated by the user is determined regularly, such as after a specific amount of time or after a specific amount of rotation of the crank axle.

In a second embodiment, the disclosure provides a system for controlling and regulating an electrical auxiliary motor suitable for a pedal-driven vehicle comprising a crank axle, such as a bicycle, said system comprising:
a) a means for receiving information about the specific torque T_{PSet} a user would like to generate when rotating said crank axle by muscular force;
b) a means for determining the actual torque T_{P} generated by the user on the crank axle; and
c) a control and calculation means;
wherein
said means for receiving information about the specific torque T_{PSet} is set up to forward said information to said control and calculation means;
said means for determining the actual torque T_{P} is set up to forward information about said torque to said control and calculation means;
said control and calculation means is set up to receive information about the specific torque T_{PSet} a user would like to generate when rotating said crank axle by muscular force from said means for receiving information about the specific torque T_{PSet}; and
said control and calculation means is set up to adjust the torque generated by the electrical auxiliary motor T_{M} in response to reception of a new T_{P} value in such a way that:
   T_{M} is increased in case T_{P} is higher than T_{PSet};
   T_{M} is not changed in case T_{P} is equal to T_{PSet};
   T_{M} is reduced in case T_{P} is lower than T_{PSet}; and
   T_{M} is 0 in case T_{P} is 0.

A simple way of implementing the control and regulation method used by the system of the second embodiment of the disclosure would be to start from the formulae:

T_{M(n+1)}=T_{M(n)}+k(T_{P}−T_{PSet})

in case T_{M(n)}+k(T_{P}−T_{PSet})>0, and

T_{M(n+1)}=0

in case T_{M(n)}+k(T_{P}−T_{PSet})≧0

wherein T_{P} and T_{PSet} have the same meaning as indicated above, T_{M(n)} is the torque generated by the electrical auxiliary motor immediately before the nth determination of the actual torque T_{P} in step b), and T_{M(n+1)} is the new torque generated by the electric auxiliary motor after the adjustment.

The reason why T_{M(n+1)=}0 in case T_{M(n)}+k(T_{P}−T_{PSet})≦0 is to avoid obtaining a braking torque generated by the electric auxiliary motor when the user generates a low pedal torque, and to reduce consumption of electricity.

The constant “k” could be chosen in different ways depending on how it is desirable to regulate the torque of the electric auxiliary motor. A high value leads to a comparatively quick response. A low value of the constant on the other hand leads to a slower response. It is possible to use different values for the constant k under different circumstances. For instance, it may be desirable to use a low value of the constant “k” when there is a large difference between T_{P} and T_{PSet}. One effect of such a regulation could be to render it simpler for the user to maintain a constant and safe speed. Furthermore, it is also possible to change value of the constant “k” based on additional parameters, such as speed, and the angle of uphill or downhill slopes. If the speed is high, it could be desirable to use a low value of k, for instance in order to save energy and/or increase safety. The same is applicable for downhill slopes. On the other hand, it could be desirable to use a higher “k” value in uphill slopes. In case these further parameters are taken into consideration, the system also includes a slope sensor and/or a speed sensor.

It is preferred that said means for receiving information about the specific torque T_{PSet} is a keypad adapted for receiving said information from the user. The keypad could be adapted for receiving information about which of a limited selection of pre-set torque values the user would like to enter. Alternatively, the user may enter a numerical value corresponding to a specific torque.

Alternatively, it is preferred that said means for receiving information about the specific torque T_{PSet} is a means for detecting an activity originating from the user and that said control and calculation means is set up to register the actual torque T_{P} as the specific torque T_{PSet}. Such a means could be a button which the user presses when he/she would like to indicate that the torque exerted by the user at that moment should be entered as T_{PSet}. Said means could also be a motion sensor or voice detection means.

As disclosed herein, the term “means for determining the actual torque T_{P} generated by the user on the crank axle” relates to any kind of torque sensor suitable for a pedal-driven vehicle comprising a crank axle. Such a means may typically be located on the crank set or on the bottom bracket. In case transfer of power in the pedal-driven vehicle is transferred to a wheel, said means for determining torque may be located in the wheel hub. In case transfer of power in the pedal-driven vehicle is transferred to said wheel using a chain, said means for determining torque may also involve measuring the strain of the chain. These different torque sensor types are well-known in the art.

As disclosed herein, the term “control and calculation means” relates to any kind of control unit suitable for being used in a low weight vehicle. Said unit, typically a microcomputer, is able to receive data from a sensor and to send data to an object to be controlled based on pre-set rules.

It is preferred that said control and calculation means is set up to determine T_{PSet} as an average of several determinations of the actual torque T_{P} that have been made during a specific period of time or at two or more consecutive passings of specific crank axle positions. Referring to the above mentioned DE 10 2009 029 655 A1 it is known that the torque exerted by the user is different in different crank axle positions. In order to obtain a stable and comfortable regulation it is therefore advantageous to use T_{PSet} values that are average values of several measurements carried out at different points of time and/or crank axle positions.

According to a first alternative, said means for determining the actual torque T_{P} is set up to determine said torque once a specific period.

According to a second alternative, said means for determining the actual torque T_{P} is set up to determine said torque when said crank axle has rotated into a specific position.

According to a third alternative, said means for determining the actual torque T_{P} is set up to determine an average of several determinations of the actual torque T_{P} that have been made during a specific period of time or two or more consecutive passings of specific crank axle positions and that this average T_{P} is used in the calculations for adjusting the torque generated by the electrical auxiliary motor. Referring to the above mentioned DE 10 2009 029 655 A1 it is known that the torque exerted by the user is different in different crank axle positions. In order to obtain a stable and comfortable regulation it is therefore advantageous to use T_{P} values that are average values of several measurements carried out at different points of time and/or crank axle positions.

In a third embodiment, the disclosure provides a power-assisted pedal-driven vehicle comprising a crank axle, and an electrical auxiliary motor such as an electrically assisted bicycle, wherein an electrical auxiliary motor assists a user in rotating said crank axle by muscular force, and where the power to move the vehicle forward is transmitted from said crank axle to driving means such as a wheel or a propeller of said power-assisted pedal-driven vehicle, wherein the electrical auxiliary motor is regulated by a system according to the second embodiment.

It is preferred that said vehicle is bicycle and in that the electrical auxiliary engine is located within the rear wheel hub.

It is preferred that the torque sensor is located on or adjacent to the crank axle. Alternatively, the torque sensor could be located within the rear wheel hub.

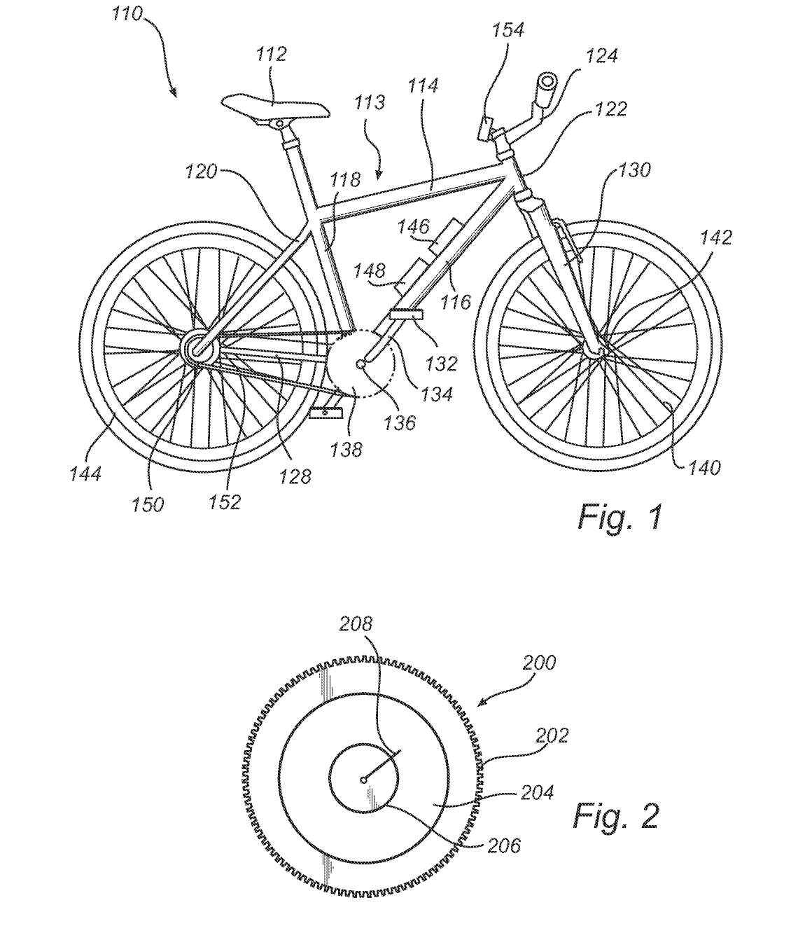

Referring now to FIG. 1, an example of a power-assisted bicycle 110 according to a preferred embodiment of the disclosure is shown. The bicycle 110 comprises typical standard parts such as a saddle 112 having a seat post, and a frame 113 comprising a top tube 114, a down tube 116, a seat tube 118, a seat stay 120, a chain stay 128, and a head tube 122. There is a handlebar 124 for steering. A fork 130 is pivotally mounted in the head tube and connected to the handlebar 124. The hub 142 of the front wheel 140 is connected to the fork. The crank axle 136 is pivotally mounted at the point where the down tube 116, the seat tube 118 and the chain stay 128 are joined to each other. Two crank arms 134 each comprising a pedal 132, as well as a chain ring 138 are mounted on the crank axle 136. The rear hub 150 of the rear wheel 144 is mounted at the point where the seat stay 120 and the chain stay 128 are joined. A chain 152 runs around the chain ring 138 of the crank set to and around a second chain ring (not shown) on the rear hub. A control and calculation means 146 and a battery 148 are typically arranged on the down tube 116. A means 154 for receiving information about the specific torque T_{PSet} a user would like to generate when rotating said crank axle by muscular force, typically a button to be pressed or a keyboard, is mounted on the handlebar 124.

Turning now to FIG. 2, a detail view of the rear hub 200 is shown. A chain ring 202 is located on the periphery of the hub 200. An electric auxiliary motor 204 is mounted inside the hub 200 around the rear axle 206 of the rear wheel 144. Electrical connection(s) 208 to the control and calculation means 146 and to the battery 148 are located within said axle 206.

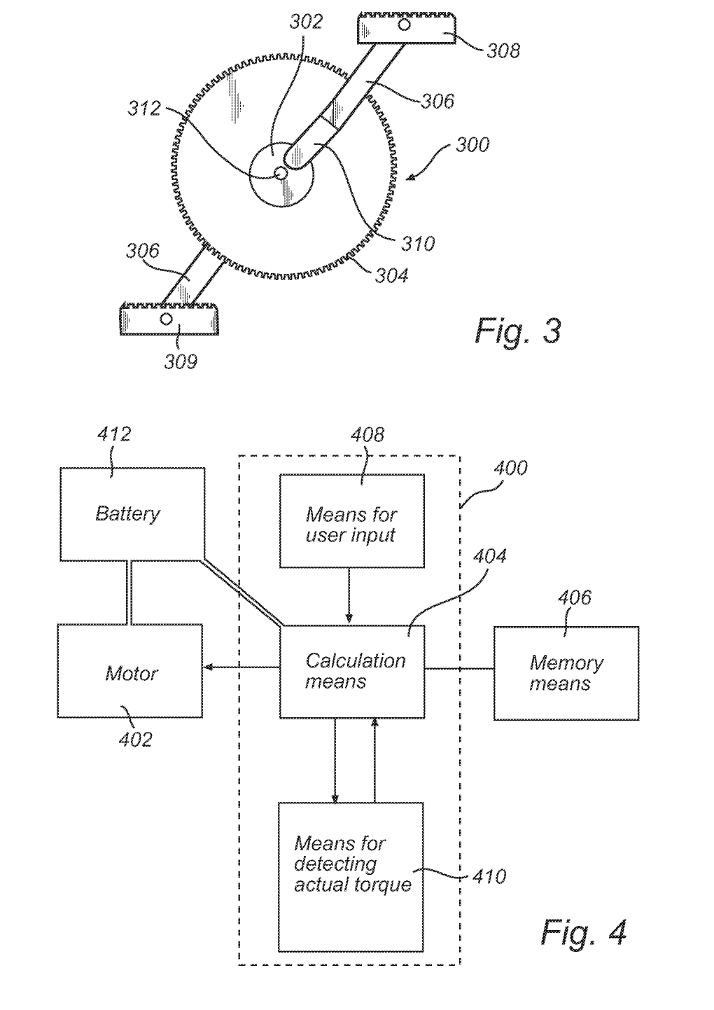

Referring now to FIG. 3, a detail view of the crank set 300 is presented. A chain ring 304 (referred to as 138 in FIG. 1) and crank arms 306 (referred to as 134 in FIG. 1) on which pedals 308, 309 (referred to as 132 in FIG. 1) are mounted are joined to the crank axle 302 (referred to as 136 in FIG. 1). A torque sensor 310 is arranged on a crank arm 306. The torque sensor 310 is connected to the control and calculation means 146 by electrical connection 312.

FIG. 4 outlines a system 400 for controlling an electric auxiliary motor 402, 204 according to an embodiment of the disclosure. The core component of the system 400 is control and calculation means 404 (referred to as 146 in FIG. 1). Said means 404 receives information from means 408 (referred to as 154 in FIG. 1) for receiving information about the specific torque T_{PSet} a user would like to generate when rotating said crank axle by muscular force, as well as from means 410 (referred to as 310 in FIG. 3) for determining the actual torque T_{P} generated by the user on the crank axle. Control and calculation means 404 uses the information received from said means 408 and 410 for continuously controlling electric auxiliary motor 402 in such a way that a user can choose the specific torque T_{PSet} he would like to exert.

The means 408 may typically be a button that the user presses when he wants the system to register the actual torque T_{P} he is producing in that moment as the specific torque T_{PSet}. In that case, the control and calculation means 404 calculates a T_{PSet} value based on data received from means 410 when the control and calculation means 404 has received an indication from means 408 that a desired T_{PSet} value is being exerted. Alternatively, the means 408 may be a keyboard for entering specific information about a desired T_{PSet} value. In that case, the control and calculation means registers the desired value as the new T_{PSet} value.

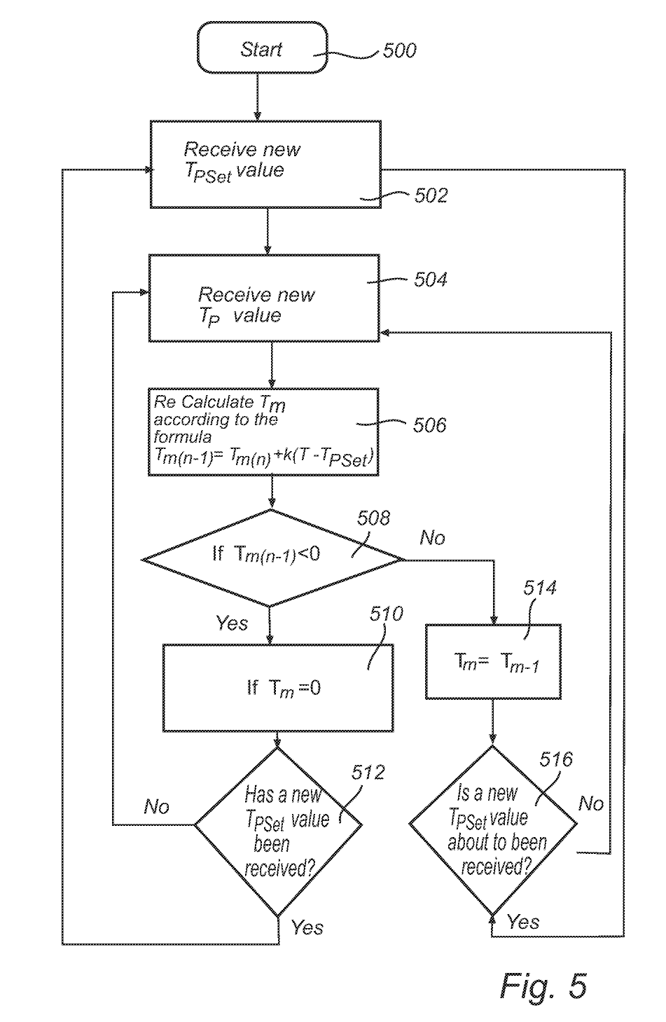

FIG. 5 specifically discloses an example of a cyclic algorithm (Step 500) for controlling the torque T_{M} exerted by the electrical auxiliary motor 204, 402. However, the figure does not show anything about changing “k” values while executing the algorithm as has been suggested above. The algorithm is initiated (Step 502) when the user enters a new T_{PSet} value, either by direct input of a desired specific T_{PSet} value or indirect input of the actual torque exerted by the user at a certain point of time as the desired specific T_{PSet} value. In the next step (Step 504), a new T_{P} value reflecting the actual torque exerted by the user is received. The torque T_{M(n+1)} that should be exerted by the electrical auxiliary motor is calculated (Step 506). In case T_{M(n)}+k(T_{P}−T_{PSet})>0 (Step 508), where T_{M(n)} is the torque exerted by the electric auxiliary motor when T_{P} was measured, T_{M(n+1)} is set to T_{M(n)}+k(T_{P}−T_{PSet}) (Step 514). When the T_{M(n+1)} value has been set, the value of the step variable n is increased to n+1 and the algorithm checks whether a new T_{PSet} value has been received (Step 516). If a new such value is about to be received, the algorithm proceeds by continuing and re-starting at the step where the value is received (Step 502). Otherwise the algorithm proceeds by continuing and re-starting at the step where a new T_{P} value is received (Step 504). In case T_{M(n+1)} as calculated in step 506 would be equal to or less than 0 (Step 508), T_{M(n+1)} is set to 0 (Step 510). When the T_{M(n+1)} value has been set, the value of the step variable n is increased to n+1 and the algorithm checks whether a new T_{PSet} value has been received (Step 512). If a new such value is about to be received, the algorithm proceeds by continuing and re-starting at the step where the value is received (Step 502).

1. A method for controlling and regulating an electrical auxiliary motor configured for a pedal-driven vehicle comprising a crank axle, in such a way that said electrical auxiliary motor assists a user in rotating said crank axle by muscular force, the method comprising:
a) receiving information about a specific torque T_{PSet} said user would like to generate when rotating said crank axle by muscular force;
b) determining an actual torque T_{P} generated by the user on the crank axle;
c) for each T_{P}, adjusting torque generated by the electrical auxiliary motor T_{M} in such a way that:
T_{M} is increased in case T_{P} is higher than T_{PSet};
T_{M} is not changed in case T_{P} is equal to T_{PSet};
T_{M} is reduced in case T_{P} is lower than T_{PSet}; and
T_{M} is 0 in case T_{P} is 0.

2. A method according to claim 1, wherein step a) is carried out in such a way that the information about the specific torque that the user would like to generate is entered manually.

3. A method according to claim 1, wherein step a) is carried out in such a way that the user indicates that the actual torque generated by the user at a specific point of time is the specific torque that the user would like to generate, and that specific torque is determined and referred to as T_{PSet}.

4. A method according to claim 1, wherein the actual torque T_{P} generated by the user is determined after a specific amount of time or after a specific amount of rotation of the crank axle.

5. A system for controlling and regulating an electrical auxiliary motor configured for a pedal-driven vehicle comprising a crank axle, said system comprising:
a) a means for receiving information about a specific torque T_{PSet} a user would like to generate when rotating said crank axle by muscular force;
b) a means for determining an actual torque T_{P} generated by the user on the crank axle; and
c) a control and calculation means;
wherein
said means for receiving information about the specific torque T_{PSet} is configured to forward said information to said control and calculation means;
said means for determining the actual torque T_{P} is configured to forward information about said actual torque to said control and calculation means;
said control and calculation means is configured to receive information about the specific torque T_{PSet} a user would like to generate when rotating said crank axle by muscular force from said means for receiving information about the specific torque T_{PSet}; and
said control and calculation means is configured to adjust torque generated by the electrical auxiliary motor T_{M} in response to reception of a new T_{P} value in such a way that:
T_{M} is increased in case T_{P} is higher than T_{PSet};
T_{M} is not changed in case T_{P} is equal to T_{PSet};
T_{M} is reduced in case T_{P} is lower than T_{PSet}; and
T_{M} is 0 in case T_{P} is 0.

6. A system according to claim 5, t wherein said means for receiving information about the specific torque T_{PSet} is a keypad adapted for receiving said information from the user.

7. A system according to claim 7, wherein said means for receiving information about the specific torque T_{PSet} is a means for detecting an activity originating from the user and wherein said control and calculation means is configured to register the actual torque T_{P} as the specific torque T_{PSet}.

8. A system according to claim 5, wherein said control and calculation means is configured to determine T_{PSet} as an average of several determinations of the actual torque T_{P} that have been made during a specific period of time or at two or more consecutive passings of specific crank axle positions.

9. A system according to claim 5, wherein said means for determining the actual torque T_{P} is configured to determine said actual torque once a specific period.

10. A system according to claim 5, wherein said means for determining the actual torque T_{P} is set up configured to determine said actual torque when said crank axle has rotated into a specific position.

11. A system according to claim 5, wherein said means for determining the actual torque T_{P} is configured to determine an average of several determinations of the actual torque T_{P} that have been made during a specific period of time or two or more consecutive passings of specific crank axle positions and wherein this average T_{P} is used in the calculations for adjusting the torque T_{M} generated by the electrical auxiliary motor.

12. A power-assisted pedal-driven vehicle comprising:
a crank axle; and
an electrical auxiliary motor,
wherein an electrical auxiliary motor assists a user in rotating said crank axle by muscular force, and where the power to move the vehicle forward is transmitted from said crank axle to driving means of said power-assisted pedal-driven vehicle, wherein the electrical auxiliary motor is regulated by a system according to claim 5.

13. A power-assisted pedal-driven vehicle according to claim 12, wherein the vehicle is a bicycle and in that the electrical auxiliary motor is located within the rear wheel hub.

14. A power-assisted pedal-driven bicycle according to claim 13, wherein a torque sensor is located on or adjacent to the crank axle.

15. A power-assisted pedal-driven bicycle according to claim 13, wherein a torque sensor is located within the rear wheel hub.
